(19) United States
(12) Patent Application Publication
(10) Pub. No.: US 2024/0227294 A1
(43) Pub. Date: Jul. 11, 2024

(54) METHODS FOR MANUFACTURING SPATIAL OBJECTS

(71) Applicants: Krzysztof Wilk, Myslowice (PL); Radoslaw Malcher, Góra (PL); Kamil Nowoczek, Drogomysl (PL); Szymon Kostrzewa, Belsk Duzy (PL); Krzysztof Roguski, Warszawa (PL); Filip Turzynski, Sopot (PL)

(72) Inventors: Krzysztof Wilk, Myslowice (PL); Radoslaw Malcher, Góra (PL); Kamil Nowoczek, Drogomysl (PL); Szymon Kostrzewa, Belsk Duzy (PL); Krzysztof Roguski, Warszawa (PL); Filip Turzynski, Sopot (PL)

(21) Appl. No.: 17/889,006

(22) Filed: Aug. 16, 2022

Related U.S. Application Data
(63) Continuation of application No. 16/360,369, filed on Mar. 21, 2019, now abandoned.

(30) Foreign Application Priority Data
Oct. 16, 2018 (PL) P427431

(51) Int. Cl. B29C 64/30; B29C 64/106; B29C 64/40; B29K 71/00; B33Y 10/00; B33Y 40/00; B33Y 70/00; C08G 8/02

(52) U.S. Cl. CPC B29C 64/30; B29C 64/106; B29C 64/40; B33Y 10/00; B33Y 40/00; B33Y 70/00; B29K 2071/00; B29K 2995/0039; B29K 2995/004; C08G 8/02

(57) ABSTRACT

Methods for producing spatial objects are disclosed. The methods generally include printing a spatial object, in an amorphous phase, using a three-dimensional (3D) printer and a printing material that consists essentially of polyaryletherketones. The methods further entail placing the spatial object in a container and submerging the spatial object in a suitable charging material. Next, vibrations are applied to the container that includes the spatial object and charging material. The container, charging material, and spatial object are then heated until the spatial object transitions into a semi-crystalline phase (at which point the spatial object can be removed from the container and charging material).

### CROSS-REFERENCE TO RELATED APPLICATIONS

This application is a continuation of U.S. patent application Ser. No. 16/360,369, filed on Mar. 21, 2019, which claims priority to Poland patent application serial number P427431, filed on Oct. 16, 2018.

### FIELD OF THE INVENTION

The field of present invention relates to methods for manufacturing spatial objects. More particularly, the field of the present invention relates to methods for manufacturing spatial objects, using three-dimensional printing devices and plastic materials that comprise (or consist essentially of) polyaryletherketones.

### BACKGROUND OF THE INVENTION

Polyaryletherketones—also commonly referred to as PAEK—is a family of thermoplastics. Polyaryletherketones are known to exhibit high-temperature stability and high mechanical strength, making such materials ideal for three-dimensional (3D) printing applications. Polyaryletherketones include a molecular backbone that contains alternating ketone (R—CO—R) and ether groups (R—O—R), with the linking R group between those functional groups consisting of a 1,4-substituted aryl group.

Polyaryletherketones are known to predominantly exist in one of two form phases, namely, an amorphous phase and a semi-crystalline phase, with each form phase differing in physicochemical properties (including differences in flexibility, hardness, and thermal resistance). In the context of plastic object manufacturing using these materials, it has been found that transition between a first phase (e.g., the amorphous phase) to a second phase (e.g., a semi-crystalline phase)—or vice versa—is often associated with changes in the state of internal stresses of the manufactured object. When such objects are manufactured using three-dimensional (3D) printers, the deposition of melted polyaryletherketone material requires strictly defined printing conditions (in one of the two phases), taking into account the desired physicochemical and heat resistance properties. It is undesirable to manufacture (print) an object partly in both phases due to the lowering of the object's strength.

Methods currently exist for 3D printing an object using polyaryletherketones, in which the object is produced in the semi-crystalline phase. In such methods, the working chamber of the 3D printer is heated to a temperature higher than the phase transition temperature, usually over 160° C. Such methods require 3D printers having more complicated constructions (and, therefore, such printers are considerably more expensive than typical 3D printers commonly found in the marketplace). In addition, such existing methods require high energy input; and support structures are more difficult to produce from dedicated materials (which complicates the final processing of the manufactured object).

Similarly, methods currently exist for 3D printing an object using polyaryletherketones, in which the object is produced in the amorphous phase. In short, after the object is initially printed, the object is heated (e.g., in an oven), which causes the object to undergo a phase transformation from the amorphous phase to the semi-crystalline phase (the desired end result for most manufacturing purposes). However, there are many disadvantages with such methods, including the occurrence of stresses within the material that comprises the object, which often leads to unwanted deformation of the object (and such deformation becomes more pronounced, as the geometric complexity of the object increases).

In view of the foregoing, it would be desirable to provide certain improved methods for manufacturing (3D printing) spatial objects using polyaryletherketones in a semi-crystalline form phase, while substantially limiting the risk of subsequent object deformation. As the following will demonstrate, the methods of the present invention address such needs in the marketplace (among others).

### SUMMARY OF THE INVENTION

According to certain aspects of the present invention, methods for producing spatial objects are provided. In certain preferred embodiments, the methods begin by printing a spatial object using a three-dimensional (3D) printer and a printing material that comprises polyaryletherketones. The invention provides that the spatial object is preferably printed in an amorphous phase. Next, the spatial object is placed into a container and submerged within a charging material. The invention provides that the charging material preferably exhibits high heat resistance properties and is chemically inert. More particularly, the invention provides that the charging material will exhibit heat resistant properties that inhibit degradation of the charging material between a glass transition temperature of the printing material (e.g., the applicable polyaryletherketones) and a melting temperature of the same printing material. Still further, the invention provides that the charging material will preferably be comprised of a granular material, which includes granules having a diameter (if spherical) or a widest cross-section (if irregular in form) between 0.05 mm and 3 mm. After the spatial object has been submerged in the container and charging material, vibrations are preferably applied to the container (to compact the charging material). Next, the invention provides that the spatial object—while submerged in the charging material within the container—is heated to a temperature (and for a period of time) that is sufficient to cause the spatial object to transition into a semi-crystalline phase (from its original amorphous phase). Finally, after the heating step above, the spatial object may then be removed from the container and charging material.

According to certain preferred aspects of the present invention, polyetheretherketones and polyetherketoneketones are the preferred printing materials used in the methods described herein. Still further, according to certain preferred aspects of the present invention, the charging material will preferably include less than 50% impurities, and still more preferably, will include less than 10% impurities and less than 10% water. Non-limiting examples of suitable charging materials include sand, quartz granules, silica granules, silicon dioxide granules, aluminum dioxide granules, steel balls, or various combinations of the foregoing. The invention provides that, even more preferably, the charging material will consist essentially of silicon dioxide granules or aluminum dioxide granules.

According to yet further aspects of the invention, the methods described herein may further include printing one or more structural supports in the amorphous phase, along with the spatial object. In such embodiments, the invention provides that the structural supports are preferably configured to (a) physically support the spatial object during printing and (b) be removed from the spatial object after the spatial object has been completely printed.

The above-mentioned and additional features of the present invention are further illustrated in the Detailed Description contained herein.

### BRIEF DESCRIPTION OF THE FIGURES

FIG. 1 is a diagram of a 3D printed object positioned within the manufacturing chamber of a 3D printer.

FIG. 2 is a diagram that shows the object featured in FIG. 1, after it has been removed from the 3D printer (and after its supports have been removed).

FIG. 3 is a diagram that shows the object featured in FIG. 2, after it has been submerged in a charging material (within a container).

FIG. 4 is a diagram that shows the object featured in FIG. 3, which is subjected to the heating step described herein.

FIG. 5 is a diagram that shows the object featured in FIG. 4, after the object has been removed from the charging material.

FIG. 6 is a flow diagram that summarizes the general steps of the methods described herein.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used, and made without departing from the scope and spirit of the invention.

As explained above, polyaryletherketones—also commonly referred to as PAEK—is a family of thermoplastics that can be used as printing materials for three-dimensional (3D) printing applications. Polyaryletherketones are known to exhibit high-temperature stability and high mechanical strength, making polyaryletherketones a favorable material for 3D printing applications. Polyaryletherketones include a molecular backbone that contains alternating ketone (R—CO—R) and ether groups (R—O—R), with the linking R group between those functional groups consisting of a 1,4-substituted aryl group.

Polyetheretherketones—also commonly referred to as PEEK—is an organic thermoplastic polymer that is a member of the PAEK family of thermoplastics, which exhibits the chemical structure shown below.

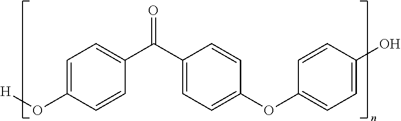

Polyetherketoneketones—also commonly referred to as PEKK—is another organic thermoplastic polymer that is also a member of the PAEK family of thermoplastics, which exhibits the chemical structure shown below.

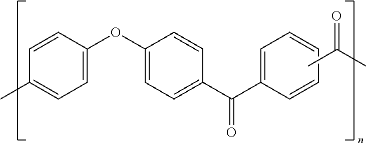

The methods for manufacturing spatial objects described herein and, more particularly, the methods for manufacturing spatial objects using three-dimensional (3D) printing devices may utilize the PAEK family of thermoplastics as printing materials, with PEEK and PEKK representing preferred printing materials. As used herein, “printing material(s),” “substrate material(s),” and similar phrases refer to substances that comprise or consist essentially of PAEK, including without limitation PEEK and/or PEKK, which are suitable for use in 3D printing applications.

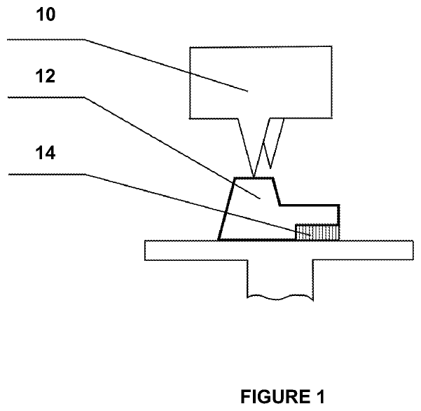

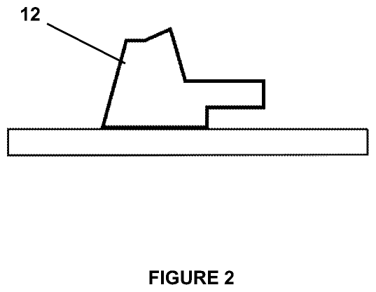

Referring now to FIGS. 1-6, according to certain preferred embodiments of the present invention, a spatial object 12 of interest may be printed/manufactured according to known procedures using commercially-available 3D printers, with the printing material substantially (or exclusively) consisting of polyaryletherketones (FIG. 1), including without limitation polyetheretherketones (PEEK) or polyetherketoneketones (PEKK). The invention provides that commercially-available 3D printers may be used to perform the methods of the present invention, including typical 3D printers currently offered by 3DGence America, Inc. (Texas, United States) and its international affiliates. In certain preferred embodiments, two independent heads 10 on the 3D printer are employed to produce/print the object 12. In such embodiments, a first of the two independent heads 10 of the 3D printer produces/prints the object 12, while a second of the two independent heads 10 of the 3D printer produces one or more structural supports 14 for the object 12. The invention provides that the one or more structural supports 14 are configured to structurally support areas of the object 12 during the printing process (which may otherwise experience mechanical failure without the aid of such supports 14). The invention provides that the object 12 will preferably be printed in the amorphous phase (i.e., a phase that lacks a crystalline structure or is otherwise less than 2% crystalline, which is often characterized or described as exhibiting a flexible, impact resistant, and transparent state). After the object 12 has been printed, the underlying structural supports 14 may then be removed from the object 12 (FIG. 2).

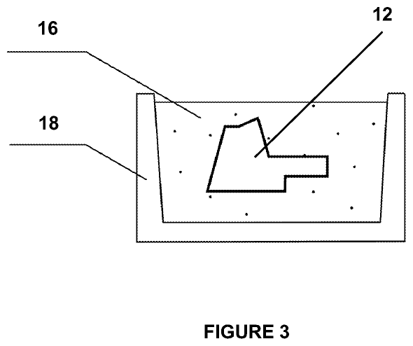

Next, the invention provides that the object 12 is backfilled with a charging material 16 (FIG. 3). More particularly, the invention provides that the object 12 is preferably deposited into a container 18 and submerged within a desired charging material 16—preferably under typical temperature conditions, such as between 140° C. and 320° ° C. or, more preferably, between 190° C. and 210° C. The object 12 should be submerged within the charging material 16 for at least 6 hours and for no more than 14 hours. As used herein, “charging material” refers to a substance that exhibits high heat resistance, no disintegration and good flow properties. More particularly, a suitable charging material 16, as used in the invention described herein, will comprise or consist essentially of a substance that exhibits (1) high heat resistance (the substance should resist breakdown or degradation between a temperature Tg (glass transition temperature) of the printed material/substrate and the melting temperature of the printed material/substrate (e.g., it should resist breakdown or degradation between 143° C. and 360° C.); (2) a bulk density of 64% to 98% volume when taken up by charging material; (3) a size or fraction of at least 0.05 mm and no more than 3 mm in diameter (if spherical) or by widest cross-section (if irregular in form), with a preferred size of 0.8 mm to 1.2 mm (in certain preferred embodiments, the charging material 16 consists of a plurality of loose spheres or granules that fall within such size parameters); (4) an impurity level of no more than 50% (but more preferably no more than 10%); and (5) a moisture (water) content of no more than 10%. The invention provides that preferred (but non-limiting) examples of such charging materials 16 include sand, quartz granules, silica granules, silicon dioxide granules, aluminum dioxide granules, metal balls (particularly steel balls), or various combinations of the foregoing, such as combinations of silicon dioxide and aluminum dioxide granules. However, the invention provides that particularly preferred charging materials consist essentially of aluminum dioxide granules or silicon dioxide granules.

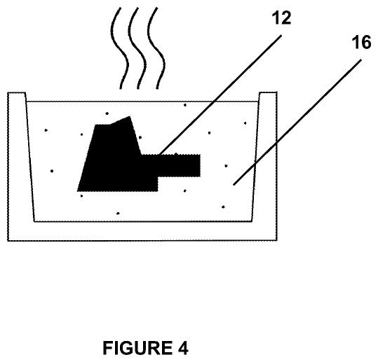

After the object 12 is deposited into a container 18 and submerged within a desired charging material 16, the charging material 16 is then compacted. More particularly, the object 12—when submerged within the charging material 16—is subject to moderate vibrations for several minutes. Such vibrations may be applied by tapping on the side of the container 18 that includes the object 12 and charging material 16. Alternatively, the container 18 may be subjected to vibrations through controlled sonication or other mechanical procedures. Following this compaction step, the container 18, together with the object 12 submerged in the charging material 16, is heated in an oven at a temperature that is no higher than the melting point of the printing material that comprises the object 12, but above the phase transition temperature of such printing material that comprises the object 12 (FIG. 4). Table-1 (below) provides exemplary minimum and maximum temperatures for this heating step, for printing materials that are substantially comprised of PEEK or PEKK.

TABLE 1

| | MIN Temp. | MAX Temp. |
|---|---|---|
| PEEK | 143° C. +/− 10% | 343° C. +/− 10% |
| PEKK | 163° C. +/− 10% | 360° C. +/− 10% |

This heating step should be performed for a period of time that is sufficient to transition the object 12 from an amorphous phase into a semi-crystalline phase. Depending on the size and dimensions of the object 12, the required period of time for this heating step will typically range between 6 hours and 14 hours. Preferably, once the object 12 is converted into a semi-crystalline phase, the object 12 is substantially crystalline in form, with the material that comprises the object 12 being no more than 80% in the amorphous phase and, preferably, no more than 65% in the amorphous phase.

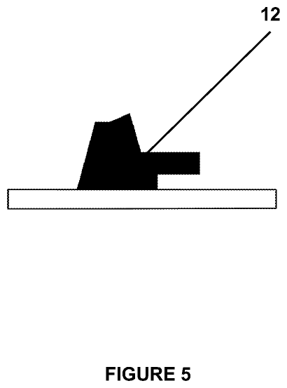

According to such methods, the invention provides that the phase transformation of the printing material that comprises the 3D-printed object 12 to the semi-crystalline phase is facilitated by the heating step described above. Furthermore, because the heating temperature is controlled, a preferably even distribution of stresses results, while the charging material 16 ensures mechanical maintenance of the geometric form of the object 12 and further inhibits the deformation of the object 12 during the phase transformation. After this heating procedure, the object 12 can be removed from the charging material 16 (FIG. 5).

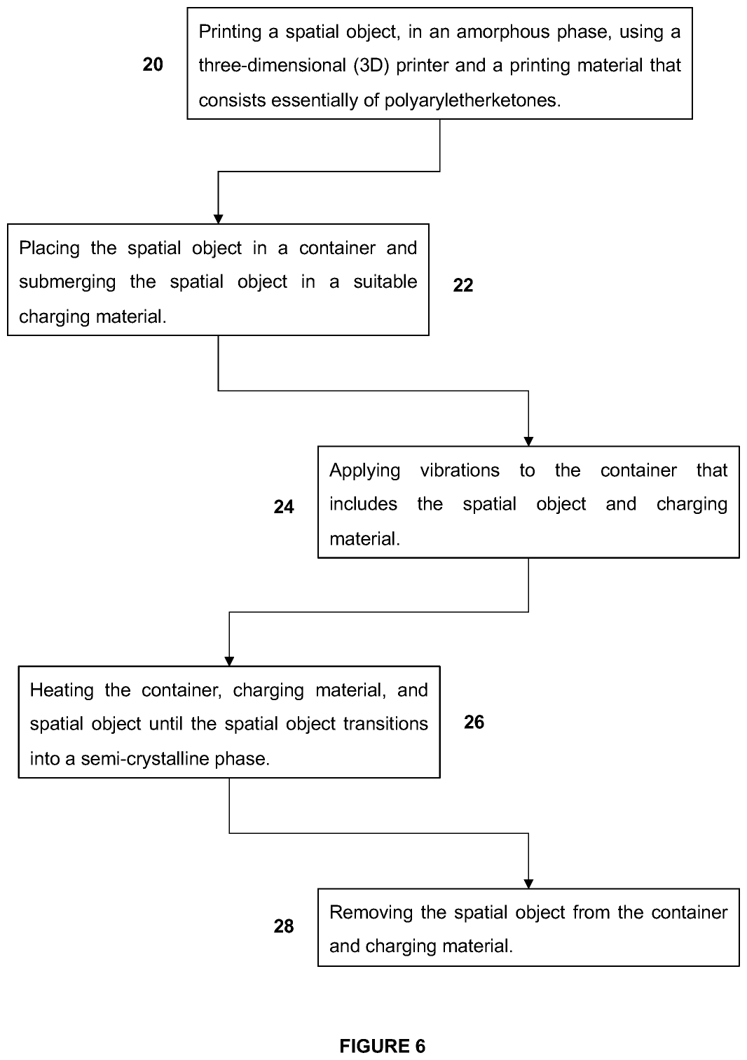

FIG. 6 provides a general summary of the methods described herein. For example, the methods generally begin by printing a spatial object 12, in an amorphous phase, using a three-dimensional (3D) printer and a printing material that consists essentially of polyaryletherketones 20. Next, the spatial object 12 is placed within a container 18 and submerged within a suitable charging material (as described above) 22. Moderate vibrations are then applied to the container 18, by tapping the container 18 or by other mechanical means 24. Next, the container 18, charging material 22, and spatial object 12 are heated until the spatial object 12 transitions into a semi-crystalline phase 26 (at which point the spatial object 12 can be removed from the container 18 and charging material 22, to complete the process 28).

The invention provides that there are many advantages provided by the methods of the present invention. For example, the methods described herein preserve the geometrical form of the object 12 produced, even after the object 12 has been converted to the semi-crystalline phase (and avoids unwanted twisting, warping, and degradation of the object 12). In addition, the methods enable 3D print operators to produce supports 14 that may be easily removed before phase transformation (from amorphous to semi-crystalline phase). Still further, the methods described herein are compatible with commercially-available 3D printers (and do not require the use of a specialized/expensive 3D printer).

The many aspects and benefits of the invention are apparent from the detailed description, and thus, it is intended for the following claims to cover all such aspects and benefits of the invention that fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A method for producing spatial objects, which comprises:
(a) printing a spatial object using a three-dimensional (3D) printer and a printing material that comprises polyaryletherketones, wherein the spatial object is printed in an amorphous phase;
(b) placing the spatial object in a container and submerging the spatial object in a charging material, wherein the charging material (i) exhibits heat resistant properties that inhibit degradation of the charging material between a glass transition temperature of the printing material and a melting temperature of the printing material; and (ii) consists essentially of a granular material, which includes granules having a diameter or widest cross-section between 0.05 mm and 3 mm;
(c) applying vibrations to the container that includes the spatial object and charging material, while the spatial object is immobilized within the charging material;
(d) heating the container that includes the spatial object and charging material until the spatial object transitions into a semi-crystalline phase; and
(e) following the heating cycle in (d) above, removing the spatial object from the container and charging material.

2. The method of claim 1, wherein the charging material is more than 50% (v/v) granular material.

3. The method of claim 1, wherein the charging material is more than 90% (v/v) granular material.

4. The method of claim 1, wherein the charging material consists essentially of sand, quartz granules, silica granules, silicon dioxide granules, aluminum dioxide granules, steel balls, or combinations of the foregoing.

5. The method of claim 1, wherein the charging material consists essentially of silicon dioxide granules or aluminum dioxide granules.

6. The method of claim 1, which further comprises printing one or more structural supports in the amorphous phase along with the spatial object, wherein the structural supports are configured to (a) physically support the spatial object during printing and (b) be removed from the spatial object after the spatial object has been completely printed.

7. A method for producing spatial objects, which comprises:
(a) printing a spatial object using a three-dimensional (3D) printer and a printing material that consists essentially of polyetheretherketones or polyetherketoneketones, wherein the spatial object is printed in an amorphous phase;
(b) printing one or more structural supports in the amorphous phase along with the spatial object, wherein the structural supports are configured to (i) physically support the spatial object during printing and (ii) be removed from the spatial object after the spatial object has been completely printed;
(c) placing the spatial object in a container and submerging the spatial object in a charging material, wherein the charging material (i) consists essentially of silicon dioxide or aluminum dioxide; and (ii) exhibits a granular form, with individual granules having a diameter or widest cross-section between 0.05 mm and 3 mm;
(d) applying vibrations to the container that includes the spatial object and charging material, while the spatial object is immobilized within the charging material;
(e) heating the container that includes the spatial object and charging material until the spatial object transitions into a semi-crystalline phase and until crystalline content of the spatial object is saturated in polyaryletherketones; and
(f) following the heating cycle in (e) above, removing the spatial object from the container and charging material.
